(19) United States
(12) Patent Application Publication
(10) Pub. No.: US 2004/0251083 A1
(43) Pub. Date: Dec. 16, 2004

(54) Tit of a step pad for a step of a step ladder

(76) Inventor: Herbert Leipziger, (US)

Correspondence Address: Herbert Leipziger, 215 Birchwood Rd., Coram, NY, 11727, US

(21) Appl. No.: 10/460,006

(22) Filed: Jun. 12, 2003

(51) Int. Cl. E06C 7/00

(52) U.S. Cl. 182/228.2; 182/165; 182/230

(57) ABSTRACT

An improved tit of a step pad for a step of a step ladder and being of the type having resiliency, a base coincident with a bottom surface of the step pad, a tip, and a pinched waist disposed between the base thereof and the tip thereof and being captured in an associated through bore in the step. The improvement includes the tip of each tit having a dimple extending axially therein to facilitate compression of the tip during insertion into the associated through bore in the step.

### BACKGROUND OF THE INVENTION

1. Field of the Invention

The present invention relates to a tit of a step pad for a step of a step ladder. More particularly, the present invention relates to an improved tit of a step pad for a step of a step ladder.

2. Description of the Prior Art

Numerous innovations for step related devices have been provided in the prior art that will be described. Even though these innovations may be suitable for the specific individual purposes to which they address, however, they differ from the present invention.

FOR EXAMPLE, U.S. Pat. No. 4,029,280 to Golz teaches a pair of screen or storm sash supporting attachments in the form of wooden blocks that are releasably secured on the step of a step ladder by U-shaped brackets. The forward ends of the attachments being provided with a plurality of spaced sash-holding lugs with anti-slip treads therebetween for holding the lower end of a screen or storm window sash from outward sliding movement.

ANOTHER EXAMPLE, U.S. Pat. No. 4,316,524 to Lapeyre teaches a ladder which can be ascended and descended at either of two rates and which comprises an array of half treads on one side of a stringer and an array of full treads on the opposite side of the stringer, each array being vertically spaced from the other along the length of the stringer. Treads are affixed to and extend from respective sides of the stringer, and at least one of the arrays includes outwardly extending portions affixed to a handrail.

STILL ANOTHER EXAMPLE, U.S. Pat. No. 5,103,608 to Andreo teaches an improved stair nosing device especially useful in temporarily darkened stairways which includes a plate member with an upper surface, at least a portion of which is covered by luminescent material. The stair nosing device includes non-slip material attached to the upper surface to provide increased frictional contact with foot traffic relative to the plate member. The non-slip material is attached as spaced apart strips with an upper surface of the non-slip material being higher relative to the plate member. In this way the luminescent material is protected from damage by foot traffic.

YET ANOTHER EXAMPLE, U.S. Pat. No. 5,111,908 to Reiter et al. teaches a pipe step for providing a flat supporting surface on the top side of a horizontal pipe. The step includes a pair of channel members each having arcs cut in the flange portions thereof to meet with the pipe. U-bolts are provided for clamping the channel members to the pipe. A flat-supporting surface formed from square mesh grating is bolted to, and extends between, the upper web portions of the channel members and provides a non-slip flat supporting surface.

YET ANOTHER EXAMPLE, U.S. Pat. No. 5,286,049 to Khan teaches a vehicle running board that has an elongated two-piece deck assembly attached to a vehicle frame by means of a plurality of longitudinally spaced brackets connected between the underside of the deck and the vehicle frame. The deck assembly includes a metal running board platform and an overlying step pad formed of plastic and having a number of integrally molded resilient tabs for effectuating a snap fit engagement with the platform. Vinyl end caps are mounted to opposite ends of the deck assembly by a pin and post connector to provide a rigid connection capable of withstanding excessive use yet capable of accommodating thermal expansion and contraction of the running board components.

STILL YET ANOTHER EXAMPLE, U.S. Pat. No. 5,587,218 to Betz teaches an improved surface covering that includes a base having a plurality of receiving grooves on one side and a plurality of working grooves on the other side. Each receiving groove includes gripping projections and is constructed to receive, and grip, a filler material. To assemble the surface material, the base material is flexed so that the size of the receiving grooves is enlarged thereby making insertion of the filler material easy. The base material is then returned to its original planar configuration, so that the size of the receiving grooves is retracted thereby causing the gripping projection to grip and hold the filler material.

YET STILL ANOTHER EXAMPLE, U.S. Pat. No. 5,692,581 to Nelson et al. teach a cover for a rung of a ladder consisting of an elongate member (12) configured to spring clamp over the rung of the ladder and a layer (16) of anti-skid or anti-slip material removeably fastened to the external surface of the cover. The elongate member includes at least one aperture (13) at each terminal end to receive a bolt for fastening the elongate member to the rung of the ladder.

STILL YET ANOTHER EXAMPLE, U.S. Pat. No. 6,088,976 to Roy teaches a removable non-skid pad that covers a portion of a corresponding step of an exterior stair or staircase so as to allow people to use it more safely. The pad includes a main section to be disposed on the upper horizontal portion of the step, a preformed substantially hooked-shaped form section having one end integrally connected to the front end of the main section so as to fit around the front edge and a part of the bottom portion of the step near the front edge, and a rear section having one end integrally connected to the rear end of the main section. A binding assembly is provided to removably attach the front and rear sections under the step. The pad may be easily installed and removed. Any snow or ice accumulations may be easily dislodged by removing the pad and skating it.

YET STILL ANOTHER EXAMPLE, U.S. Pat. No. 6,497,304 to Leipziger teaches an improved step ladder of the type having at least one step and a corresponding number of step pads. The improvement includes each step pad being replaceably and interchangeably attached to an associated step, each step having a plurality of throughbores extending vertically therethrough, each step pad having a plurality of tits depending therefrom that replaceably and interchangeably engage in the plurality of throughbores in the associated step, respectively, and each tit having a wide base coincident with the associated step pad, a pointed tip that facilitates entering into an associated throughbore, and a pinched waist which is releasably captured in the associated throughbore when the pointed tip passes into the associated throughbore, a distance requiring the tit to compress so as to allow the pinched waist to receive the step and then expand to releasably capture the step in the pinched waist, and as a result thereof, releasably lock the step pad onto the associated step.

Specifically, with reference to FIGS. 1-3, which are, respectively, a diagrammatic perspective view of a prior art step ladder in use, an enlarged diagrammatic cross sectional view taken along LINE 2-2 in FIG. 1, and an enlarged diagrammatic elevational view of the area generally enclosed by the dotted curve identified by ARROW 3 in FIG. 2 of a tit of a step pad of the prior art step ladder, and in which like numerals indicate like parts, the prior art step ladder is shown generally at 10.

The prior art step ladder 10 is of the type having at least one step 12 and a corresponding number of step pads 14.

Each step 12 has a top surface 16 and a bottom surface 18, and each step pad 14 has a bottom surface 20 abutting the top surface 16 of an associated step 12 and is replaceably and interchangeably attached to an associated step 12.

Each step 12 further has a plurality of throughbores 22 extending vertically therethrough, from the top surface 16 thereof to the bottom surface 18 thereof, and which are equally spaced-apart from each other.

Each step pad 14 further has a plurality of tits 24 depending from the bottom surface 20 thereof, and which replaceably and interchangeably engage in the plurality of throughbores 22 in the associated step 12, respectively, and which depend equally spaced-apart from each other.

Each tit 24 is resilient and has a wide base 26 coincident with the bottom surface 20 of an associated step pad 14, a pointed tip 28 that is narrower than the wide base 26 thereof so as to facilitate entering into an associated throughbore 22, and a pinched waist 30 that is disposed between the wide base 26 thereof and the pointed tip 28 thereof and which is releasably captured in the associated throughbore 22 when the pointed tip 28 of the tit 24 passes into the associated throughbore 22 a distance requiring the tit 24 to compress so as to allow the pinched waist 30 of the tit 24 to receive the step 12 and then expand to releasably capture the step 12 in the pinched waist 30 of the tit 24, and as a result thereof, releasably lock the step pad 14 onto the associated step 12.

It is apparent that numerous innovations for step related devices have been provided in the prior art that are adapted to be used. Furthermore, even though these innovations may be suitable for the specific individual purposes to which they address, however, they would not be suitable for the purposes of the present invention as heretofore described.

### SUMMARY OF THE INVENTION

ACCORDINGLY, AN OBJECT of the present invention is to provide an improved tit of a step pad for a step of a step ladder that avoids the disadvantages of the prior art.

ANOTHER OBJECT of the present invention is to provide an improved tit of a step pad for a step of a step ladder that is simple and inexpensive to manufacture.

STILL ANOTHER OBJECT of the present invention is to provide an improved tit of a step pad for a step of a step ladder that is simple to use.

BRIEFLY STATED, YET ANOTHER OBJECT of the present invention is to provide an improved tit of a step pad for a step of a step ladder and being of the type having resiliency, a base coincident with a bottom surface of the step pad, a tip, and a pinched waist disposed between the base thereof and the tip thereof and being captured in an associated through bore in the step. The improvement includes the tip of each tit having a dimple extending axially therein to facilitate compression of the tip during insertion into the associated through bore in the step.

The novel features which are considered characteristic of the present invention are set forth in the appended claims. The invention itself, however, both as to its construction and its method of operation, together with additional objects and advantages thereof, will be best understood from the following description of the specific embodiments when read and understood in connection with the accompanying drawing.

### BRIEF DESCRIPTION OF THE DRAWING

The figures of the drawing are briefly described as follows:

FIG. 1 is a diagrammatic perspective view of a prior art step ladder in use;

FIG. 2 is an enlarged diagrammatic cross sectional view taken along LINE 2-2 in FIG. 1;

FIG. 3 is an enlarged diagrammatic elevational view of the area generally enclosed by the dotted curve identified by ARROW 3 in FIG. 2 of a tit of a step pad of the prior art step ladder;

FIG. 4 is an elevational of the improved tit of the present invention of a step pad for a step of a step ladder; and

FIG. 5 is an enlarged diagrammatic bottom plan view taken generally in the direction of ARROW 5 in FIG. 4 illustrating the dimple extending axially in the tip of the improved tit of the present invention.

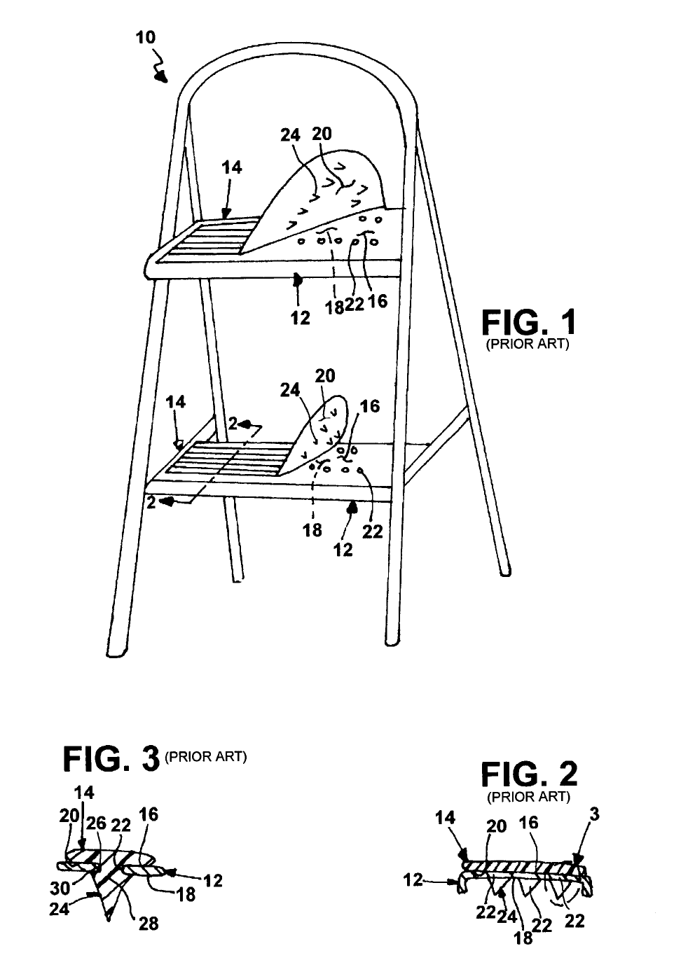

### LIST OF REFERENCE NUMERALS UTILIZED IN THE DRAWING

Prior Art

10 step ladder

12 at least one step

14 corresponding number of step pads

16 top surface of each step of at least one step 12

18 bottom surface of each step of at least one step 12

20 bottom surface of step pad of corresponding number of step pads 14

22 plurality of throughbores in each step of at least one step 12

24 plurality of tits of each step pad of corresponding number of step pads 14

26 wide base of each tit of plurality of tits 24 of each step pad of corresponding number of step pads 14

28 pointed tip of each tit of plurality of tits 24 of each step pad of corresponding number of step pads 14

30 pinched waist of each tit of plurality of tits 24 of each step pad of corresponding number of step pads 14

Present Invention

110 step ladder

114 step pad

124 improved tit of present invention of step pad 114 for step 12 of step ladder 110

132 dimple extending axially in tip 128 of each tit 124

### DETAILED DESCRIPTION OF THE INVENTION

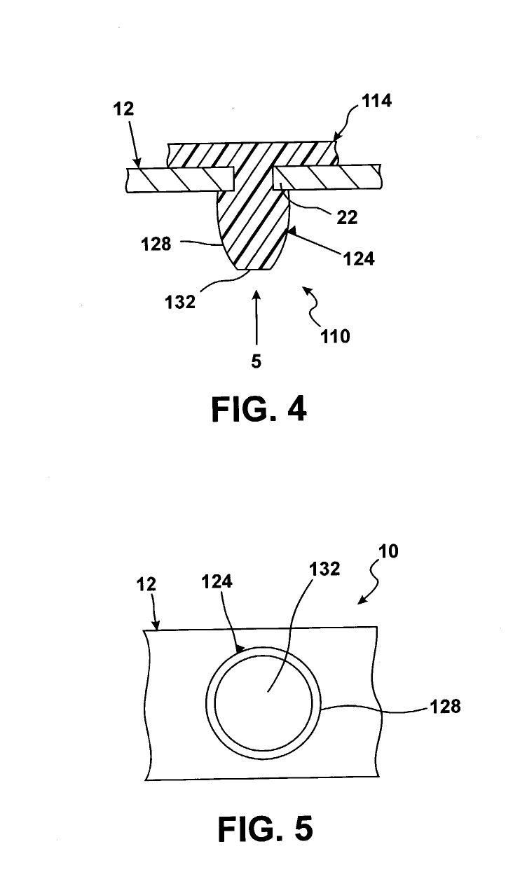

Referring now to FIGS. 4 and 5, which are, respectively, an elevational of the improved tit of the present invention of a step pad for a step of a step ladder, and an enlarged diagrammatic bottom plan view taken generally in the direction of ARROW 5 in FIG. 4 illustrating the dimple extending axially in the tip of the improved tit of the present invention, the improved tit of the present invention is shown generally at 124 of a step pad 114 for a step 12 of a step ladder 110.

The improvement comprises the tip 128 of each tit 124 having a dimple 132 extending axially therein to facilitate compression of the tip 128 during insertion into an associated through bore 22 in the step 12.

It will be understood that each of the elements described above, or two or more together, may also find a useful application in other types of constructions differing from the types described above.

While the invention has been illustrated and described as embodied in an improved tit of a step pad for a step of a step ladder, however, it is not limited to the details shown, since it will be understood that various omissions, modifications, substitutions and changes in the forms and details of the device illustrated and its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute characteristics of the generic or specific aspects of this invention.

The invention claimed is:

1. An improved tit of a step pad for a step of a step ladder and being of the type having resiliency, a base coincident with a bottom surface of the step pad, a tip, and a pinched waist disposed between the base thereof and the tip thereof and being captured in an associated through bore in the step, said improvement comprising:
the tip of each tit having a dimple extending axially therein to facilitate compression of the tip during insertion into the associated through bore in the step.
